(19) United States
(12) Patent Application Publication
(10) Pub. No.: US 2011/0268489 A1
(43) Pub. Date: Nov. 3, 2011

(54) Linear Roll Tensioning System for Continuous Web Printer

(75) Inventors: Jonathan Azar, Lincoln, RI (US); Louis Verte, JR., West Greenwich, RI (US)

(73) Assignee: ASTRO-MED, INC., Warwick, RI (US)

(21) Appl. No.: 12/768,840

(22) Filed: Apr. 28, 2010

(51) Int. Cl. B41J 15/16

(52) U.S. Cl. 400/618

(57) ABSTRACT

An improved back tensioning system for a roll fed printer is provided. A spring loaded arm keeps a roller in direct contact with the outer diameter of the unwind roll. The roller is coupled to a slip clutch that exerts a constant force against the roll of media. Since this system does not apply a torque about the axis of rotation, as was the case in the prior art, the back tension does not vary with unwind roll size. As a result, linear back tension is provided in a manner that critically improves web handling and the printing process. As a result the problem is eliminated by applying resistance directly to the outer diameter of the roll of media.

### BACKGROUND OF THE INVENTION

The present invention relates generally to back tensioning assemblies for controlling web tension on roll unwinding systems such as roll fed printers. More specifically, the present invention relates to an improved back tensioning assembly for a roll fed printer that insures consistent tensioning of the paper web regardless of the amount of paper remaining on the roll.

It is known that bulk quantities of paper or plastic sheeting or web materials can economically be distributed in the form of rolls. Further, rolled webs also facilitate efficiency when using bulk quantities of these materials in various machines such as printers. When dispensing such materials the paper or plastic web is pulled to unwind it from the roll. In some cases equipment is utilized to unwind the material from the roll while in other applications the material is unwound manually by pulling on the material. As an example, a paper web that is used in roll fed printing equipment is supplied on rolls that are mounted to a supply end of a bulk-printing machine and drawn into the printer by a traction device.

The rolls are generally rotatably supported on a mounting apparatus or in a cradle that facilitates unwinding of the roll and supply of the paper web to the printer. Often the rolls are mounted onto a mandrel assembly that is in turn supported on a mounting frame. As the paper is drawn from the roll, the roll rotates freely about the mandrel. This prior art mandrel assembly, however, does not provide the ability to apply tension to the paper roll as it unwinds, except for whatever rotational friction is generated between the mandrel and the roll. In the absence of tension, paper backlash may occur when the traction drive is stopped to cut the paper r to align the next print job. Excess backlash can separate the paper from the printer or cause the paper to jerk beneath the print head producing an unsatisfactory product. In other words, the roll of material can keep turning even after the printer has suddenly stopped pulling the web forward, which causes the material to lose tension and slacken resulting in extra material hanging loosely from the roll. Then, when the web is quickly pulled forward again, the slack is taken out before the roll begins turning, causing the material to rip or jerk. This is particularly problematic in computer printers and other apparatus where the webs are pulled from the roll intermittently such that the web movement starts, the paper roll accelerates, and when the web movement stops the roll must decelerate. During deceleration, the roll tends to continue turning and can result in the spewing of the paper between the roll and the printer feed devices.

Various techniques have been proposed in the prior art to counteract roll overspin and maintain back tension forces on the paper. These have involved pinch rollers that engage the paper between the roll and the infeeding device or weights that drag on the roll so as to establish fictional forces between the roll and a roller on which the roll rests. Other devices employ a tension roller that rests on a rotating arm against the outer surface of the paper. The problem in this arrangement is that as the roll unwinds the relative angle of the arm changes causing variation in the tension applied to the roll as well as changes in the feed characteristics and angle of the web being fed. Other solutions have included the provision of a frictional clutch at the central spindle or mandrel to which the roll is mounted. The difficulty in these arrangements is that the force of the paper back tension is equal to the torque of the clutch divided by the radius of the roll. Accordingly, as the roll unwinds the back tension applied to the web increases as the diameter of the roll decreases.

Accordingly, there is a need for an apparatus that can apply a uniform back tension force to a media roll. There is a further need for an apparatus that can maintain constant back tension on a roll of media being unwound regardless of the radius of the roll or the material remaining on the roll. There is still a further need for an apparatus that applies linear back tensioning force to a web of material that remains constant despite the rate of feed or the media or the amount of media remaining on the roll.

### BRIEF SUMMARY OF THE INVENTION

In this regard, the general purpose of the present invention, which will be described subsequently in greater detail, is to provide an improved back tensioning system for roll fed media such as paper web media for a bulk printer. Back tension is the resistance applied by the feeder system to the printer in order to control tracking. When a roll of media unwinds and a torque is applied about the axis of the unwinding roll to generate back tension, the force increases as the size of the roll decreases. This increase in force is due to the fact that the back tension force is equal to the frictional torque applied by the roller divided by the radius of the media roll causing an increase in force as the radius decreases due to the payout of the web. In contrast, the present invention system controls back tension by applying a constant resistance directly to the outer surface of the unwind roll of media. A spring loaded arm keeps a roller in direct contact with the outer diameter of the unwind roll. The roller is coupled to a slip clutch that exerts a constant force against the roll of media. Since this system does not apply a torque about the axis of rotation, as was the case in the prior art, the back tension does not vary with unwind roll size. As a result, linear back tension is provided in the present invention in a manner that critically improves web handling and the printing process. As a result, the problem is eliminated by applying resistance directly to the outer diameter of the roll of media.

It is therefore an object of the present invention to provide an apparatus that can apply a uniform back tension force to a media roll. It is a further object of the present invention to provide an apparatus that can maintain constant back tension on a roll of media being unwound regardless of the radius of the roll or the material remaining on the roll. It is still a further object of the present invention to provide an apparatus that applies linear back tensioning force to a web of material that remains constant despite the rate of feed or the media or the amount of media remaining on the roll.

These together with other objects of the invention, along with various features of novelty that characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In the drawings which illustrate the best mode presently contemplated for carrying out the present invention:

FIG. 1 is a front perspective view of the back tensioning assembly of the present invention;

FIG. 2 is a cross sectional view taken along line 2-2 of FIG. 1; and

FIG. 3 is a side view of the back tensioning system of the present invention incorporated into a media feed system for a printer.

### DETAILED DESCRIPTION OF THE INVENTION

Now referring to the drawings, an improved back tensioning system for roll fed media is shown and described in the figures. A back tensioning system as disclosed herein is described generally in the context of a roll fed media system for a device such as a bulk printer. However one skilled in the art can appreciate that the disclosure herein may be applied equally well to any roll fed material in any context including paper feed stock for printing or any other manufacturing process, label feedstock for printing and/or labeling applications and plastic sheeting materials for printing and/or packaging.

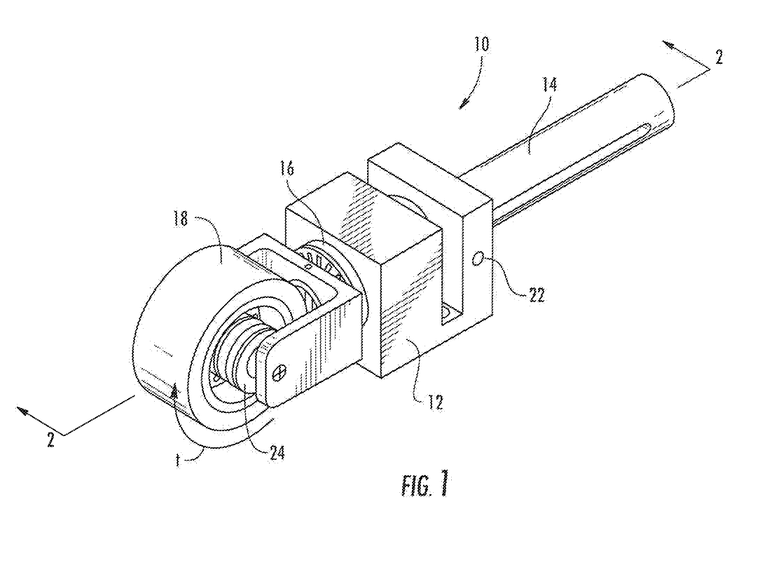

Turning to FIG. 1, back tension is the resistance applied by the feeder system to the media being feed in order to control tracking of the media through the system. The resistance force applied by the back tensioning system of the present invention is indicated by the arrow labeled “t”. As is known in the prior art, when a roll of media unwinds and a resistance force in the form of torque applied about the rotational axis of the unwinding roll to generate back tension, the force increases as the size of the roll decreases. This increase in force is due to the fact that the back tension force is equal to the torque applied by the roller divided by the radius of the media roll causing an increase in force as the radius decreases due to the payout of the web. In contrast, the present invention system controls back tension by applying a constant resistance directly to the outer surface of the unwind roll of media.

As can be seen at FIG. 1, the back tensioning system 10 of the present invention generally includes a mounting assembly 12 that supports the back tensioning system relative to the device in which it is installed. A support shaft 14 is installed into the mounting assembly 12 and is linearly translatable relative thereto. In one embodiment the support shaft 14 may simply extend into a bore that extends through the mounting assembly 12. More preferably a linear bearing 16 is provided in the bore to facilitate the smooth linear movement of the support shaft 14. The support shaft 14 can further be seen to include a central axis that extends between a first end and a second end thereof. Still further the assembly can be seen to include a roller 18 that is rotatably received on the first end of the support shaft 14.

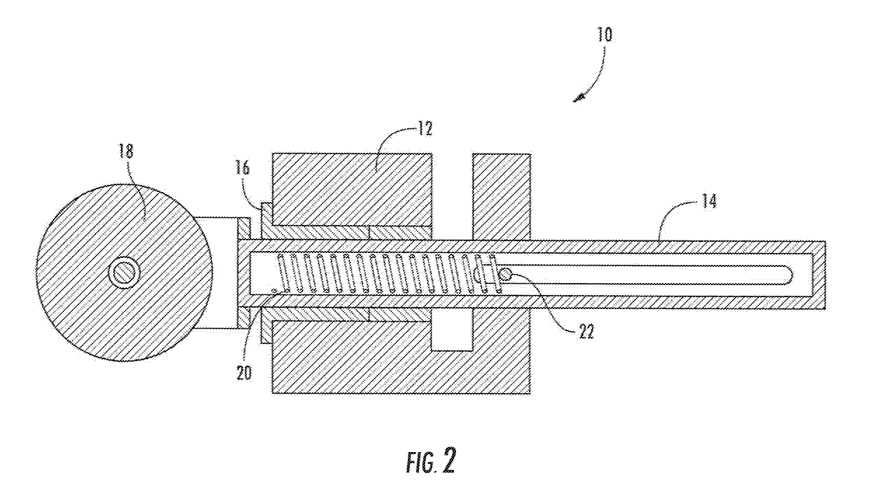

As can best be seen referring to FIG. 2 in connection with FIG. 1, a spring 20 is provided that urges the first end of the support shaft 14 in a first direction away from the mounting assembly 12. In this manner, the spring 20 applies a linear force to the support shaft 14 that in turn keeps the roller 18 in direct contact with the outer diameter of the unwind roll. It can be seen that in the preferred embodiment the spring 20 is provided in a cavity formed centrally within the support shaft 14. A pin 12 is provided to capture the spring 20 between the first end of the support shaft 14 and the mounting assembly 12. This allows the spring force to exert uniform force in extending the roller 18 forward as the diameter of the media roll decreases thereby maintaining constant drag on the media roll. It should be appreciated by one skilled in the art that while a coil spring captured on the interior of the support shaft is shown, the coil spring may also be provided about the exterior of the support shaft as well. In that arrangement the coil spring would extend between the first end of the support shaft and the face of the mounting assembly.

The roller 18 is rotatably supported at the first end of the support shaft 14. The roller 18 is of any suitable material that will exert frictional force against the outer surface of the media roll. In the preferred embodiment the outer surface of the roller is urethane, although any other suitable material would also fall within the scope of the invention. The roller 18 is rotatably supported on a shaft and is preferably coupled to a slip clutch 24 that exerts a constant resistance force against the roller rotation, which in turn exerts a constant force against the rotation of the roll of media. The force exerted by the slip clutch 24 may be constant or may be adjustable to allow a user to properly set and calibrate the tension of the overall system.

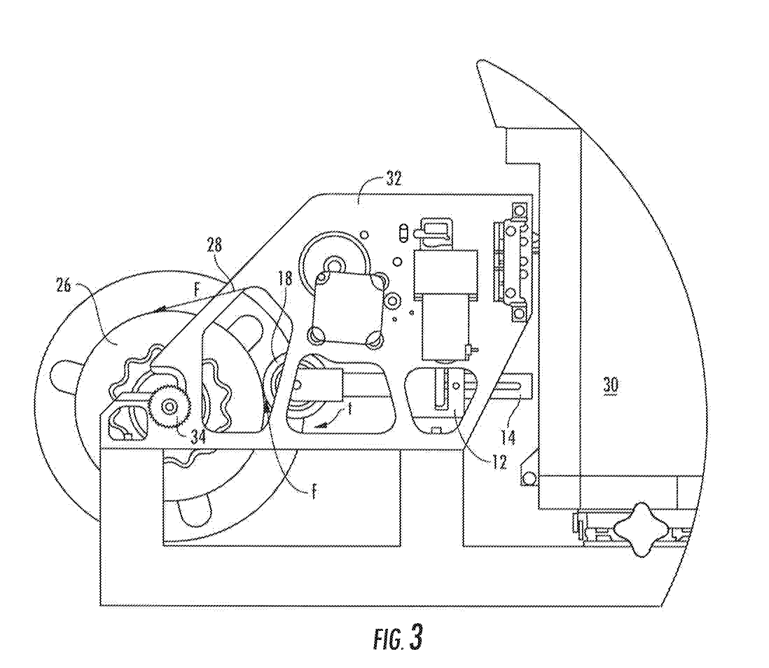

As can be seen in FIGS. 2 and 3, the slip clutch 24 provides a torsional force against rotation of the roller 18, represented as the arrow labeled “t”. The roller 18 in turn exerts a force “f” against the rotation of the media roll 26 wherein the force “f” is equal to the torque “t” times the radius “r” of the roller. This resistance force “f” is equal to the back tension force “F” that acts against the advancing web of media 28. What is unique in the present invention is that since this system does not apply a torque about the axis of rotation of the media roll, as was the case in the prior art, the back tension force “F” does not vary with unwind roll size because at all times F=f and f is only a function of the torque applied by the slip clutch and the diameter of the roller with no impact as a result of the size of the unwind roll. As a result, linear back tension is provided in the present invention in a manner that critically improves web handling and the printing process. As a result, the problem is eliminated by applying resistance directly to the outer diameter of the roll of media.

To assist in maintaining constant force against the outer surface of the unwind roll it is preferred that the back tensioning system have a central axis that extends through the support shaft and along the axis of the linear motion of the support shaft. It is further preferred that the central axis be offset relative to the axis of rotation of the roll of media. Still further it is preferred that eh central axis be offset relative to the axis of rotation of the media in a direction that is opposite the rotation of the roll. This prevents the dynamic force of the rotation of the roll from overcoming the spring force that extends the roller forward and effectively reducing the back tension placed on the roll due to slippage or skipping.

As can best be seen in FIG. 3 the present invention may be incorporated into a media feed system for a printer 30. The media feed system may be formed as an integral component of the printer 30 itself or may be provided as an additional component or a retrofit assembly. In any case, the media feed system includes a frame 32 that is configured for engagement with a printer device 30. Further the frame 32 has a support means 34 for rotatably receiving a roll of media 26 and feeding the media to the printer. The back tensioning system is attached to the frame via the mounting assembly that supports the back tensioning system. As was described above, a support shaft is installed into the mounting assembly and is linearly translatable relative thereto. A roller is rotatably supported at the first end of the support shaft and is preferably coupled to a slip clutch that exerts a constant resistance force against the roller rotation, which in turn exerts a constant force against the rotation of the roll of media. The force exerted by the slip clutch may be constant or may be adjustable to allow a user to properly set and calibrate the tension of the overall system. In all other aspects the device functions as already described herein.

It can therefore be seen that the present invention provides an apparatus that can apply a uniform back tension force on a roll of media being unwound regardless of the radius of the roll or the material remaining on the roll. Further, the present invention provides an apparatus that applies linear back tensioning force to a web of material that remains constant despite the rate of feed or the media or the amount of media remaining on the roll. For these reasons, the instant invention is believed to represent a significant advancement in the art, which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. A back tensioning system for roll fed media, comprising:
a mounting assembly;
a support shaft having a central axis extending between a first end and a second end, said support shaft being received in said mounting assembly and linearly translatable relative thereto;
a spring that urges said first end of said support shaft in a first direction away from said mounting assembly; and
a roller received on the first end of the mounting shaft.

2. The back tensioning system of claim 1, further comprising;
a slip clutch engaged with said roller that provides resistance against rotation of said roller.

3. The back tensioning system of claim 2, wherein the resistance of said slip clutch is adjustable.

4. The back tensioning system of claim 1, wherein said spring urges said roller into contact with an outer surface of a roll of media, said roller exerting a uniform resistance against rotation of the roll of media.

5. The back tensioning system of claim 4, further comprising;
a slip clutch engaged with said roller that provides resistance against rotation of said roller.

6. The back tensioning system of claim 5, wherein the resistance of said slip clutch is adjustable.

7. The back tensioning system of claim 4, wherein central axis of the shaft is vertically offset relative to an axis of rotation of said roll of media.

8. A back tensioning system for roll fed media, comprising:
a frame;
support means within said frame for receiving a roll of media, said media being rotatable relative to said support means; and
a back tensioning assembly including:
a mounting assembly affixed to said frame;
a support shaft having a central axis extending between a first end and a second end, said support shaft being received in said mounting assembly and linearly translatable relative thereto;
a roller received on the first end of the mounting shaft; and
a spring that urges said first end of said support shaft in a first direction into contact with an outer surface of said roll of media, said roller exerting a uniform resistance against rotation of the roll of media.

9. The back tensioning system of claim 8, further comprising;
a slip clutch engaged with said roller that provides resistance against rotation of said roller.

10. The back tensioning system of claim 9, wherein the resistance of said slip clutch is adjustable.

11. The back tensioning system of claim 8, wherein central axis of the shaft is vertically offset relative to an axis of rotation of said roll of media.

12. The back tensioning system of claim 8, wherein said frame is configured for engagement with a printer device wherein said roll fed media is supplied to said printer.

13. A media feed system for a printer, comprising:
a frame configured for engagement with a printer device;
support means within said frame for receiving a roll of media and feeding said media to said printer; and
a back tensioning assembly including:
a mounting assembly affixed to said frame;
a support shaft having a central axis extending between a first end and a second end, said support shaft being received in said mounting assembly and linearly translatable relative thereto;
a roller received on the first end of the mounting shaft; and
a spring that urges said first end of said support shaft in a first direction into contact with an outer surface of said roll of media, said roller exerting a uniform resistance against rotation of the roll of media.

14. The media feed system of claim 13, further comprising;
a slip clutch engaged with said roller that provides resistance against rotation of said roller.

15. The media feed system of claim 14, wherein the resistance of said slip clutch is adjustable.

16. The media feed system of claim 13, wherein central axis of the shaft is vertically offset relative to an axis of rotation of said roll of media.
